(19) United States
(12) Patent Application Publication
(10) Pub. No.: US 2005/0263113 A1
(43) Pub. Date: Dec. 1, 2005

(54) Combustion type nailing machine

(75) Inventor: Yoshitaka Akiba, Ibaraki (JP)

Correspondence Address: McGinn & Gibb, PLLC, Suite 200, 8321 Old Courthouse Road, Vienna, VA, 22182-3817, US

(73) Assignee: Hitachi Koki Co., Ltd., Tokyo (JP)

(21) Appl. No.: 11/124,112

(22) Filed: May 9, 2005

(30) Foreign Application Priority Data
May 10, 2004 (JP) P2004-140268

(51) Int. Cl. F02F 1/00

(52) U.S. Cl. 123/46 H; 123/193.6

(57) ABSTRACT

A combustion type nailing machine includes: a cylinder; a piston movably supported in the cylinder; a combustion chamber provided in an upper portion of the cylinder, the combustion chamber in which mixture of fuel and air is burned so as to drive the piston; a driver blade integrated with the piston, for ejecting a nail when the piston is driven; and at least two piston rings with which a seal between an outer periphery of the piston and an inner wall of the cylinder are maintained, the piston rings each having one opening portion. The piston rings are superimposed on each other such that the opening portions are shifted not to overlap with each other.

### BACKGROUND OF THE INVENTION

1. Field of the Invention

The present invention relates to a combustion type nailing machine.

2. Background Art

The combustion type nailing machine broadly includes: a housing, a handle, a trigger switch, a cylinder head, a combustion chamber frame, a push lever, a cylinder, piston, a driver blade, a motor, a fan, a gas canister, an ignition plug, an exhaust gas check valve, a magazine and a tail cover. The cylinder head having a plurality of holes, through which air can flow, is arranged in an upper portion of the housing, and the handle is fixed to the housing and attached with a trigger switch. The combustion chamber frame is arranged being capable of moving in the housing in the longitudinal direction and pushed by a spring in the direction opposite to the direction of the cylinder head. However, one end of the combustion chamber frame comes into contact with the cylinder head resisting a pushing force of the spring.

The push lever is movably provided at the other end of the housing and connected to the combustion chamber frame. The cylinder is located being capable of communicating with the combustion chamber frame and fixed to the housing and guides a movement of the combustion chamber frame. Further, an exhaust hole is formed in the cylinder. The piston is provided being capable of reciprocating with respect to the cylinder. When one end portion of the combustion chamber frame comes into contact with the cylinder head, the piston defines a combustion chamber together with the cylinder head, the combustion chamber frame and the cylinder head side end portion of the cylinder. The driver blade is extended from the opposite combustion chamber side of the piston to the direction of the other end portion of the housing. The motor is supported by the cylinder head, and the fan is fixed to a rotary shaft of the motor and located in the combustion chamber. The fan mixes combustible gas with air in the combustion chamber so as to facilitate the combustion of mixture gas. When the combustion chamber frame is separated from the cylinder heads the fan introduces the outside air into the housing so as to scavenge the inside of the combustion chamber frame. Further, the fan cools the outer surface of the cylinder. The gas canister is accommodated in the housing and contains liquefied combustible gas to be injected into the combustion chamber via a gas passage of the cylinder head. The ignition plug faces the combustion chamber and ignites a mixture of the combustible gas and air. The exhaust check valve selectively closes the exhaust hole of the cylinder.

The magazine is arranged on the other end portion side of the housing and accommodates clamps such as nails. The tail cover is arranged between the magazine and the push lever so that the clamp accommodated in the magazine can be fed to a position opposed to the driver blade.

In order to air-tightly close the combustion chamber when the combustion chamber frame comes into contact with the cylinder head, the sealing members (seal rings) are respectively provided on a predetermined face of the cylinder head closely coming into contact with the upper portion of the combustion chamber frame and on the cylinder head side end portion of the cylinder closely coming into contact with the lower portion of the combustion chamber frame.

When the push lever is pressed against a workpiece and the trigger switch is turned on, liquefied gas in the canister accommodated in the housing is injected into the combustion chamber while the combustion chamber is being defined, and air and combustible gas are stirred and mixed with each other by the fan. Then, the mixture is ignited by the ignition plug and burned being exploded. Therefore, the piston is moved and a nail is driven into the workpiece such as a piece of timber through the driver blade. Until a predetermined period of time passes after the completion of exploding combustion, the combustion chamber frame is kept coming into contact with the cylinder head. When the exhaust check valve is closed after the combustion gas has been discharged, the combustion chamber is air-tightly closed. At the same time, due to a decrease in pressure in the combustion chamber caused by a reduction of the temperature, thermal vacuum is obtained on the combustion chamber side. Accordingly, the piston can be raised by a difference in pressure between the upper portion and the lower portion of the piston. (For example, refer to U.S. Pat. No. 4,403,722)

The characteristic of this combustion type nailing machine is that the maneuvering property is excellent because it is unnecessary to provide a compressor and air hose like the conventional compressive air type nailing machine.

### SUMMARY OF THE INVENTION

For example, as described in U.S. Pat. No. 5,558,264, the outer circumference of the piston and the inner wall of the cylinder are sealed from each other by two piston rings. As shown in FIG. 3, the piston ring 50 is formed into a C-shape, and the opening portion 51 is provided at one portion of the piston ring 50. As shown in FIG. 4, the piston ring 50 is attached in each of the two grooves formed on the piston 10 as described later. Therefore, the upper and the lower portion of the piston 10 are communicated with each other via the two opening portions 51 as shown by the arrow in the drawing. Accordingly, there is a possibility that the pressure leaks at the time of exploding combustion. As a result, there is a possibility that the driving force to drive a nail is decreased.

It is an object of the present invention to provide a nailing machine, the structure of which is simple, in which the above problems are solved and the driving force to drive a nail is not lowered.

The above object can be accomplished when the piston rings are provided being put on each other while the opening portions of the piston rings are shifted from each other so that the opening portions can not overlap with each other.

According to the present invention, when at least two piston rings are provided being put on each other, it is possible to prevent a leakage of pressure at the time of exploding combustion. Therefore, a decrease in the driving force can be previously prevented. Further, it is possible to reduce the thickness of the piston. Therefore, the piston can be made lighter and the manufacturing cost can be decreased. Furthermore, the piston can be positively returned. The present invention can provide the above operational effects.

### BRIEF DESCRIPTION OF THE DRAWINGS

The present invention may be more readily described with reference to the accompanying drawings:

FIG. 1 is a partially sectional view showing an initial state of an embodiment of the nailing machine of the present invention.

FIG. 2 is a sectional view showing a relation between the piston and the piston ring.

FIG. 3 is a perspective view showing an example of the piston ring.

FIG. 4 is a sectional view showing a relation between the piston and the piston ring of the conventional nailing machine.

### DETAILED DESCRIPTION OF THE PREFERRED EMBODIMENTS

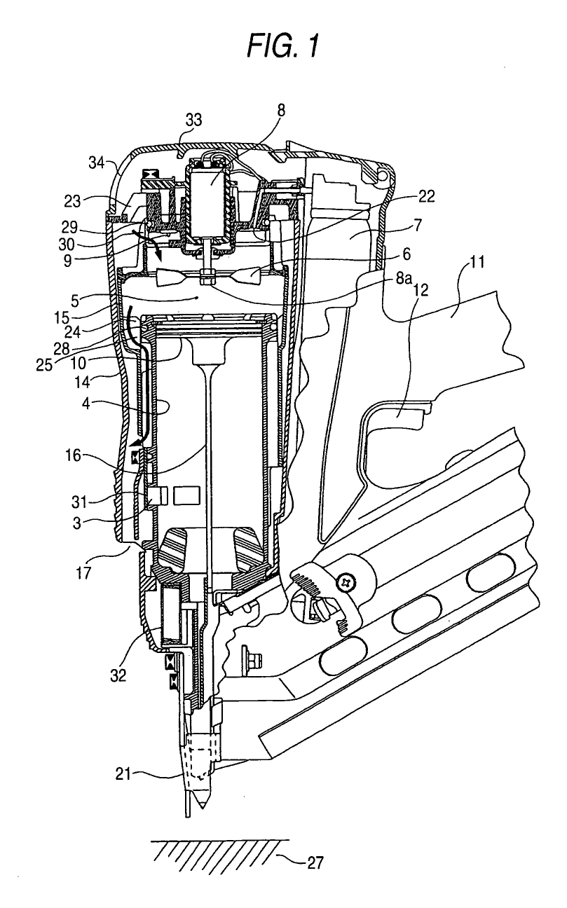

Referring to FIG. 1 showing an embodiment of the nailing machine of the present invention, the configuration and operation of the nailing machine will be explained below. FIG. 1 is a view showing an initial state of the nailing machine before conducting operation. The essential configuration is substantially the same as that explained in the description of the related art, and the operation from combustion to scavenging are substantially the same as that explained in the description of the prior art. Therefore, the explanations will be briefly made here.

There are provided a cylinder 4 and cylinder head 23 which are fixed in the housing 14 forming the main body frame. At the intermediate position, the combustion chamber frame 15 connected to the push lever 21 is movably attached being pushed by the spring 32 so that the combustion chamber frame 15 can be moved upward and downward. Although the sealing members 28, 29 are provided in an upper portion of the cylinder 4 and a lower portion of the cylinder head 23, the flow passages 25, 30 are communicated with the outside air and the combustion chamber 5 is not air-tightly closed. In the cylinder 4, the piston 10, to which the driver blade 16 is attached, is supported being guided, and the exhaust hole 3 having a check valve 31 is provided outside in the lower portion of the cylinder 4. In the combustion chamber 5, the fan 6 is provided which is attached to a forward end portion of the rotary shaft 8a of the motor 8 and rotated by the motor 8. Further, the injection port 22 for injecting liquefied combustible gas, which is sent from the gas canister 7, the igniting section of the igniting plug 9 and the protruding rib 24 are provided in the combustion chamber 5.

The trigger switch 12 is provided on the handle 11 of the housing 14. In the housing 14, the head switch (not shown) is provided which detects that the tool body is pressed against a piece of timber 27 and the combustion chamber frame 15 is located at an upper end of the stroke. The head cover 33, on which the opening 34 is provided, is arranged in an upper portion of the cylinder head 23.

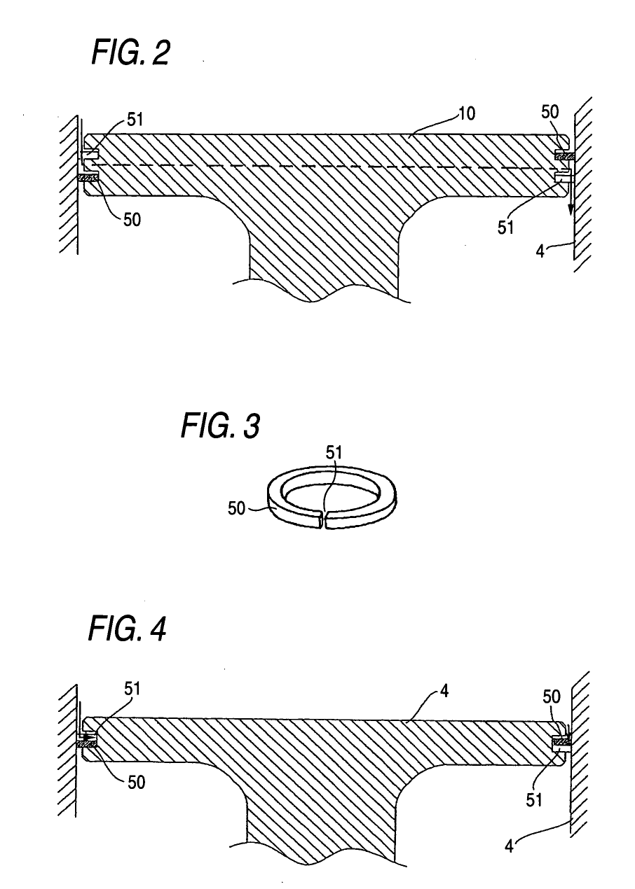

When the push lever 21 is pressed against the piece of timber 27 in the above state, in the same manner as that described before, the combustion chamber frame 15 is raised, and the flow passages 25, 30 are closed by the sealing members 28, 29. Therefore, the combustion chamber 5 becomes an air-tightly closed space with respect to the atmosphere. In this state, first, while being linked with a rise of the combustion chamber frame 15, the combustible liquefied gas in the gas canister 7 is injected from the injection port 22 into the combustion chamber 5. When the combustion chamber frame 15 is raised to the uppermost end portion, the head switch is turned on, and then the fan 6 is rotated. The liquefied combustible gas and air are mixed and stirred in turbulence by the rotation of the fan 6 and by the action of the rib 24. When one of the head switch and the trigger switch 12 is turned on, the fan 6 starts rotating. When the other of the head switch and the trigger switch 12 is turned on, the spark plug 9 is ignited by the spark ignition circuit. The piston 10 is driven downward by the combustion and expansion of the mixture, so that a nail can be driven into the piece of timber 27. When the piston 10 is lowered to a position close to the bottom dead point, the exhaust hole 3 of the cylinder 4 is communicated with an upper chamber of the piston 10, and the combustion gas of high pressure and temperature is exhausted into the atmosphere via the check valve 31 and the opening 17, and the combustion chamber 5 is decompressed. When the pressure in the combustion chamber 5 is reduced to the atmospheric pressure, the check valve 31 is shut off and the space is air-tightly closed. Due to the thermal vacuum caused by this rapid quench, the piston 10 is returned to the initial position while the combustion chamber 5 is being air-tightly closed. After that, when the tool body is lifted and separated from the piece of timber 27 and the trigger switch 12 is turned off, the combustion chamber 5 is released from the air-tightly closed state so that the combustion chamber 5 can be open to the atmosphere. Since the fan 6 is continuously being rotated by the control circuit not shown, it is stopped after the remaining combustion gas is scavenged from the combustion chamber 5, and the state is returned to the initial state shown in FIG. 1. At the time of scavenging conducted by the fan 6, the air flows as follows. The air flows from an upper portion of the head cover 33 to the opening 34 and further flows from the flow passage 30 into the combustion chamber 5 via the fan 6. The air passes through the flow passage 25 and flows out from the combustion chamber 5. Further, the air flows on the outer circumference of the cylinder 4 and then flows out from the opening 17, which is located in the lower portion of the housing 14, into the outside air. In this connection, concerning the piston rings 50, in order to simplify the expression in the drawing, it is shown that two piston rings 50 are attached being separate from each other. However, actually, two piston rings 50 are attached being put on each other as shown in FIG. 2 as described later.

FIG. 2 is a sectional view showing an embodiment of the piston 10 and the piston ring 50 composing the present invention. At least two piston rings 50 are attached while the opening portions 51 of the two piston rings 50 are being shifted from each other.

As a result of attaching the two piston rings 50 in such a manner that the opening portions 51 are shifted from each other, the upper and the lower face of the piston 10 are not communicated with each other. Accordingly, there is no possibility that the pressure generated at the time of exploding combustion leaks out from the opening portions 51 of the two piston rings 50. Therefore, the driving force is not lowered, and at the same time, when thermal vacuum is generated, a difference in pressure between the upper and the lower face can be maintained. Accordingly, the piston can be positively returned to the initial position. Due to the above structure, it becomes possible to reduce the thickness of the piston 10, that is, the piston 10 can be made lighter. As a result, the piston can be easily, positively returned. Further, since the weight of the piston 10 is reduced, it is possible to increase the driving speed of the piston 10. As a result, an intensity of the driving energy can be increased. The present invention can provide the above operational effects.

1. A combustion type nailing machine, comprising:
a cylinder;
a piston movably supported in the cylinder;
a combustion chamber provided in an upper portion of the cylinder, the combustion chamber in which mixture of fuel and air is burned so as to drive the piston;
a driver blade integrated with the piston, for ejecting a nail when the piston is driven; and
at least two piston rings with which a seal between an outer periphery of the piston and an inner wall of the cylinder are maintained, the piston rings each having one opening portion;
wherein the piston rings are superimposed on each other such that the opening portions are shifted not to overlap with each other.

2. A combustion type nailing machine, comprising:
a housing;
a cylinder head that covers an end of the housing;
a push lever that is provided below the housing and that is movable when the nailing machine is pressed on a workpiece;
a cylinder that is fixed in the housing;
a piston that slidably reciprocates with respect to the cylinder in an axial direction of the cylinder;
a driver blade fixed to the piston and for ejecting a nail;
a combustion chamber frame that is movably guided by the cylinder in the housing, the combustion chamber frame movable along with a movement of the push lever to abut with and separate from the cylinder head so as to define a combustion chamber along with the cylinder head, the cylinder, and the piston; and
at least two piston rings with which a seal between an outer periphery of the piston and an inner wall of the cylinder are maintained, the piston rings each having one opening portion;
wherein the piston rings are superimposed on each other such that the opening portions are shifted not to overlap with each other.
